(19) United States
(12) Patent Application Publication
(10) Pub. No.: US 2015/0222508 A1
(43) Pub. Date: Aug. 6, 2015

(54) UBIQUITOUS COMPUTING (UBICOMP) SERVICE DETECTION BY NETWORK TOMOGRAPHY

(71) Applicant: EMPIRE TECHNOLOGY DEVELOPMENT, LLC, Wilmington, DE (US)

(72) Inventor: Ezekiel Kruglick, Poway, CA (US)

(21) Appl. No.: 14/350,771

(22) PCT Filed: Sep. 23, 2013
(86) PCT No.: PCT/US13/61254

§ 371 Date: Aug. 7, 2014

(51) Int. Cl. H04L 12/26

(52) U.S. Cl. CPC H04L 43/0817

(57) ABSTRACT

Technologies are generally described to employ network tomography to detect an uncooperative device and identify services associated with the uncooperative device. In some examples, employing network tomography over a probed network segment between two or more cooperative devices may enable an activity of cooperative and/or any uncooperative device(s) on the network to be profiled. A service finder application may then be executed to compare an activity profile of the uncooperative device against activity profiles of known network devices within an identification database to identify one or more services. Action strategies may then be determined within an action database, and an action may be suggested to enable cooperation and cross-use of the uncooperative device within the network based on recognized services. Example action strategies may include enabling installation of software, prompting of a user to perform an action, and/or arranging for cooperation.

### BACKGROUND

Unless otherwise indicated herein, the materials described in this section are not prior art to the claims in this application and are not admitted to be prior art by inclusion in this section.

Discovery of ubiquitous computing (ubicomp) devices on a network may be difficult when the ubicomp devices do not advertise their services or use network discovery protocols. Ubicomp providers may have entire ecosystems, the ecosystems including ubicomp devices in many places around a home, a business, or the like. Such providers may have a number of smart ubicomp devices as well as less smart ubicomp devices scattered around the home or the business. If the collection of smarter ubicomp devices could detect and specifically identify less smart ubicomp devices that do not advertise their capabilities, the system may be able to arrange service connections and acquire needed software to connect the smarter ubicomp devices to the unadvertised ubicomp devices.

Current discovery and identification systems may rely on devices cooperatively identifying themselves and their services. The current systems may not allow legacy devices to be identified because the older legacy devices may have dedicated desktop software for a narrow expected use of the device at the time the device was sold and may not know new exchange methods. Furthermore, many device vendors may not advertise their device or capabilities of the device, rendering the current systems ineffective.

### SUMMARY

The present disclosure generally describes techniques to detect an uncooperative device and identify services associated with the uncooperative device.

According to some examples, a method to detect an uncooperative device and identify services associated with the uncooperative device is provided. An example method may include probing exchanged data between two or more cooperative devices spanning a network segment over which the uncooperative device communicates and processing data from the probed network segment within a tomography module of each of the two or more cooperative devices. The method may also include using the processed data from each tomography module to identify one or more suspected services through an identification database. The method may further include sending the identified services to an action database and suggesting one or more actions to enable interaction with the uncooperative device.

According to other examples, a service to detect an uncooperative device and identify services associated with the uncooperative device is described. An example service may include an identification database, an action database, and one or more servers configured to execute a service finder application. The service finder application may be configured to receive data from tomography modules of two or more cooperative devices, where the two or more cooperative devices share a network segment over which the uncooperative device communicates. The service finder application may also be configured to use the processed data from each tomography module to identify one or more suspected services associated with the uncooperative device through an identification database. The service finder application may further be configured to send the identified services to the action database, and suggest one or more actions from the action database to enable interaction with the uncooperative device.

According to further examples, a server to detect an uncooperative device and identify services associated with the uncooperative device is described. An example server may include a memory configured to store instructions, a communication module; and a processor coupled to the memory and the communication module, the processor operable to execute a control manager. The control manager may be configured to probe exchanged data between two or more cooperative devices spanning a network segment over which the uncooperative device communicates. The control manager may also be configured to use the probed data to identify one or more suspected services associated with the uncooperative device through an identification database. The control manager may further be configured to send the identified services to an action database and suggest one or more actions to enable interaction with the uncooperative device.

According to some embodiments, a cooperative networked computing device to detect an uncooperative device and identify services associated with the uncooperative device is described. The computing device may include a memory configured to store instructions, a communication module, and a processor coupled to the memory and the communication module, the processor operable to execute a tomography module. The tomography module may be configured to probe data exchanged with another cooperative device over a network segment over which the uncooperative device communicates and capture and process the data from the probed network segment. The tomography module may also be configured to send the processed data to an identification database through the communication module and perform one or more actions provided by an action database based on an identification of the uncooperative device using the processed data to enable interaction of the uncooperative device.

According to other embodiments, a computer readable memory device with instructions stored thereon is described, which when executed on one or more computing devices may execute a method for detecting an uncooperative network device and identifying associated services. The method may be similar to the example method discussed above.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system to employ network tomography between two or more cooperative devices;

FIG. 2 illustrates an example system to execute a service finder application to detect an uncooperative device, identify services associated with the uncooperative device, and provide one or more actions to enable interaction with the uncooperative device;

FIG. 3 illustrates a structure of an example network in which network tomography may be employed to detect an uncooperative device and identify services associated with the uncooperative device;

FIG. 4 illustrates a general purpose computing device, which may be used to detect an uncooperative device and identify services associated with the uncooperative device;

FIG. 5 is a flow diagram illustrating an example method to detect an uncooperative device and identify services associated with the uncooperative device that may be performed by a computing device such as the computing device in FIG. 4; and

FIG. 6 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to detection of an uncooperative device and services associated with the uncooperative device.

Briefly stated, technologies are generally described to employ network tomography to detect an uncooperative device and identify services associated with the uncooperative device. In some examples, employing network tomography over a probed network segment between two or more cooperative devices may enable an activity of cooperative and/or any uncooperative device(s) on the network to be profiled. A service finder application may then be executed to compare an activity profile of the uncooperative device against activity profiles of known network devices within an identification database to identify one or more services. Action strategies may then be determined within an action database, and an action may be suggested to enable cooperation and cross-use of the uncooperative device within the network based on recognized services. Example action strategies may include enabling installation of software, prompting of a user to perform an action, and/or arranging for cooperation.

A cooperative device, as described herein, is a smart device that may communicate over a network with multiple other smart devices on the network. The cooperative device may detect the other smart devices and be aware of services the other smart devices offer. The cooperative device may also communicate services the device itself offers, enabling cross-use of smart devices within the network. An uncooperative device, as described herein, is a device that may not identify itself or advertise all its capabilities to cooperative devices on a network on which the device resides. Consequently, the uncooperative device may not be detectable by the other devices on the network and/or may not be able to communicate services the device offers, preventing cross-use with other devices on the network. The uncooperative device may be a ubiquitous computing (ubicomp) device.

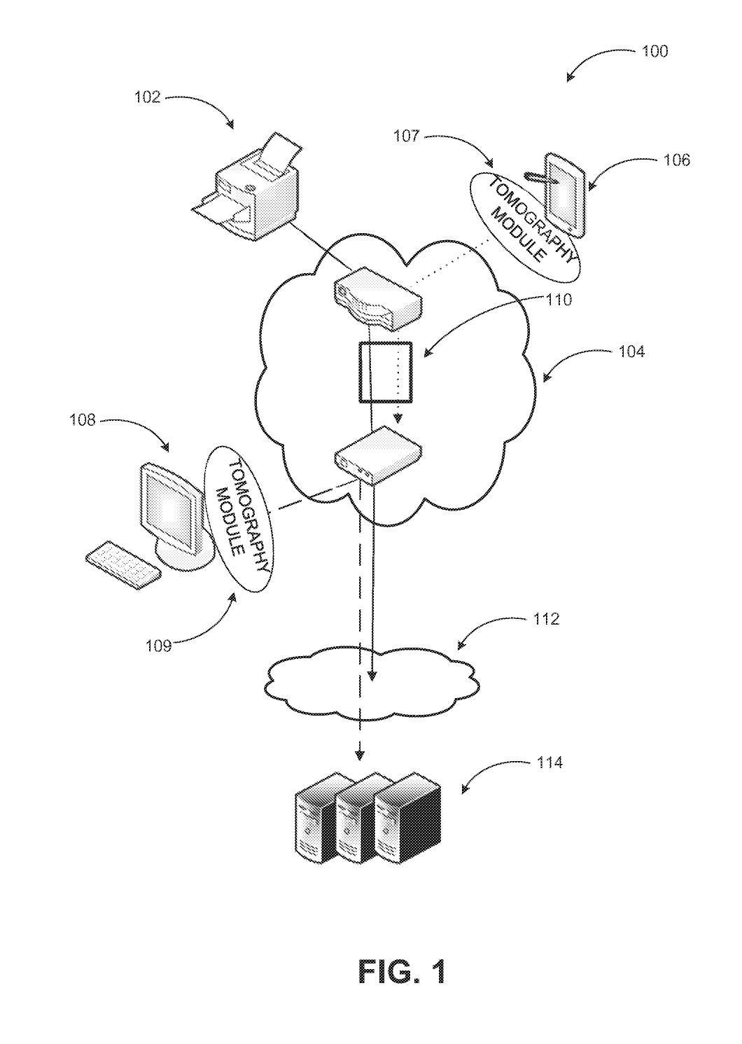

FIG. 1 illustrates an example system to employ network tomography between two or more cooperative devices, arranged in accordance with at least some embodiments described herein.

As shown in a diagram 100, within a network 104, an uncooperative device (for example, a printer 102) may be on a shared network segment 110 with two or more cooperative devices. The cooperative devices may be client devices (for example, a tablet 106 and a computer 108), where the cooperative devices may be on a same network, as illustrated in FIG. 1, or on two distinct networks. The uncooperative device may be coupled to a second network 112 comprising a datacenter 114. The networks 104, 112 may be one of a wide area network (WAN), a local area network (LAN), a wireless local area network (WLAN), Bluetooth, or other similar network.

The tablet 106 and the computer 108 may exchange data over the network segment 110 shared with the printer 102, which may be probed by tomography modules 107, 109 of the tablet 106 and the computer 108, respectively. The tomography modules 107, 109 may process data from the probed network segment by employing network tomography. Network tomography is the computational act of measuring small variations in network traffic delivery times at different nodes and performing central computation to extract detailed profiles of traffic over time and target. A system according to some embodiments may employ network tomography between two or more cooperative devices on a network to characterize other traffic on the network, classify the traffic by known and unknown devices of origin, and produce speculation on the nature of other devices. The speculated nature may then be used to suggest and/or engage in one or more actions, such as downloading compatibility packs and instructing users how to set their uncooperative devices to communicate with the smarter, cooperative devices.

The probed network segment may be decomposed into linearly independent components enabling subtraction of known signals of cooperative devices on the network, including the tablet 106 and the computer 108, from suspected signals of the printer 102 to detect the printer 102. Processed tomography data may include activity profiles for the cooperative devices and/or any uncooperative device(s), such as the printer 102 on the network 104. The activity profiles may include or indicate patterns and statistics of network traffic associated with each device. The tomography data may be sent from the tomography modules 107, 109 to one or more servers executing a service finder application. The service finder application may be configured to transfer the tomography data received from the tomography modules 107, 109 to an identification database, where the service finder application may employ the identification database to identify one or more suspected services of the printer 102. The suspected services may be detected by comparing the activity profile of the printer 102 to activity profiles of the known devices on the network 104 stored in the identification database. For example, the patterns and statistics within the activity profile of the printer may be compared to patterns and statistics within the activity profiles of known devices on the network 104, such as a another printer or a fax machine. Through comparison, the patterns and statistics unique to the printer 102 may be identified, enabling one or more suspected services to be detected from those unique patterns and statistics within the activity profile of the printer 102. The suspected services that are recognized may then be sent by the service finder application to an action database, where the service finder application may suggest one or more actions from the action database to enable interaction with the printer 102. The one or more actions may include enabling installation of software, prompting of a user to perform an action, and/or arranging for cooperation.

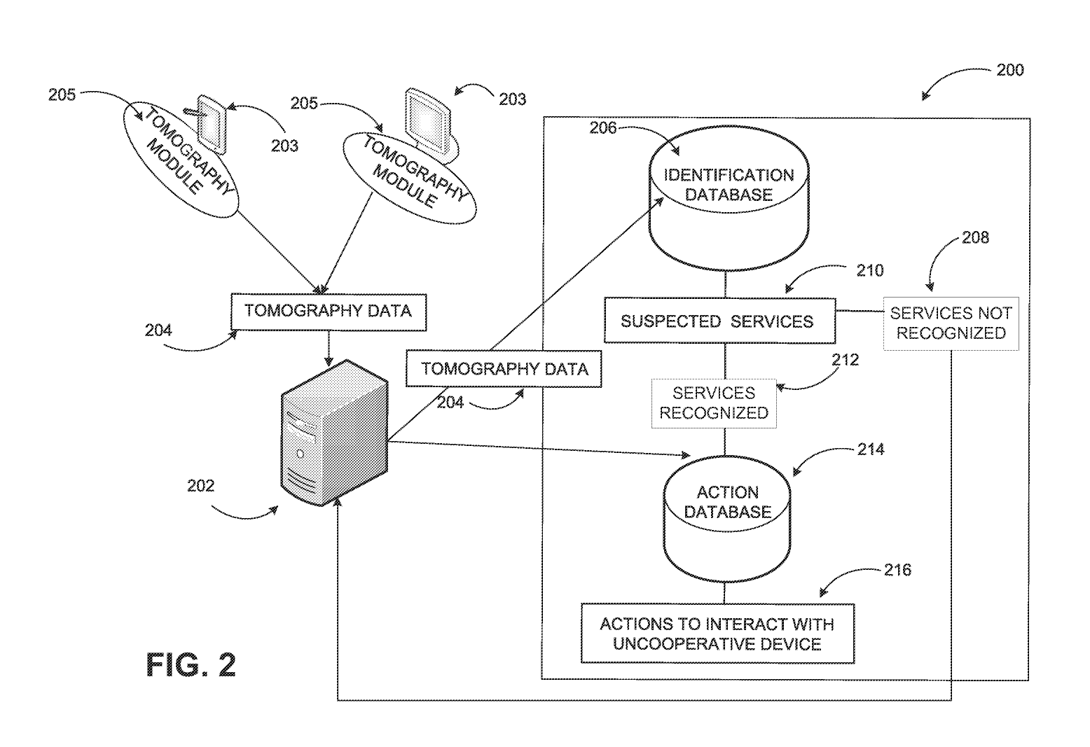

FIG. 2 illustrates an example system to execute a service finder application to detect an uncooperative device, identify services associated with the uncooperative device, and suggest one or more actions to enable interaction with the uncooperative device, arranged in accordance with at least some embodiments described herein.

As shown in a diagram 200, the example system may include a server 202, an identification database 206, and an action database 214. The server 202 may execute a service finder application, which may be a local application or a cloud application, associated with two or more cooperative devices 203, such as the tablet and the computer discussed previously in FIG. 1. Tomography modules 205 of the cooperative devices may capture and process data exchanged between the cooperative devices spanning a network segment by probing the network segment. The probed network segment may include the communications of an uncooperative device, such as the printer discussed previously in FIG. 1.

The processed tomography data 204 may be transferred from the tomography modules of the cooperative devices to the server 202, which may execute the service finder application. The tomography data 204 may include activity profiles of known devices and/or any uncooperative device(s) on the network. The activity profiles may include or indicate patterns and statistics of network traffic of each device on a network. The service finder application may be configured to transfer the tomography data to the identification database 206, where the service finder application may identify one or more suspected services of the uncooperative device by employing the identification database 206. The suspected services may be identified by comparing the activity profiles of the known devices stored in the identification database 206 to the activity profile of the uncooperative device on the network.

For example, a given sample of tomographically extracted network behavior may be compared probabilistically with stored expected behavior of many potential devices to generate a probability that the observed behavior comes from each potential device. The probability that an uncooperative device is a potential device may be updated (e.g. through Bayesian updating of probability based on previous characterization of expected behavior of each potential device) with further samplings until an acceptable level of certainty is reached. The conclusion may indicate multiple possible devices and a user may be prompted to clarify which device type is on their network, for example via a dialog box or selection window.

Comparison of the activity profiles of the known devices to the activity profile of the uncooperative device may enable unique network traffic of the uncooperative device to be identified enabling the identification of the suspected services. The identification database 206 may list the identified services suspected to be responsible for observed network traffic and a certainty of their recognition (for example, operation 210). If suspected services are not recognized and/or the certainty of the suspected services recognition are low (for example, below a predefined threshold), the service finder application may request for further tomography data 204 to be processed within the tomography modules 205 of the cooperative devices 203 (for example, operation 208). Alternatively, if suspected services are recognized, the service finder application may be configured to send the recognized services to an action database 214 (for example, operation 212).

The service finder application, may suggest one or more actions from the action database 214 to enable interaction with and/or usage of the uncooperative device (for example, operation 216). The suggested actions may include instructions to prompt a user to perform an action, delivery and installation of software to one or more detected devices, and/or arrangement of co-operation between the uncooperative device and the cooperative devices. For example, software may be delivered to the detected uncooperative device with suspected services. The software may try to determine if the detected uncooperative device indeed offers the suspected services and install itself for future use or install another program for future communication with the uncooperative device. Thus, cooperation of legacy and less ubicomp-friendly devices with a more advanced ecosystem of devices may be enabled.

In an example scenario, a printer may have a feature enabling a device to email a file to a unique email address for the printer. When an application executing the feature forwards and/or sends an email with an attachment to the unique email address, the email may be received at a datacenter where one or more servers may process the email into a printer-specific print-job. The one or more servers of the datacenter may send the processed email over a network to the printer, complete with pauses to accommodate buffers, bidirectional status, and/or error traffic. While the printer may be used by any ubicomp device in principle, there is no network interaction advertised or any other way for a ubicomp device to interact with the printer through the unique email address without knowing about the printer from an outside source.

In the example scenario, tomography modules of two or more cooperating devices on the network shared with the printer may process tomography data that observes print job traffic that is not associated with any previously known printer. The print traffic may have characteristic sizing and timing for a specific printer device, and may correlate with a specific network, such as a wide area network (WAN) or a local area network (LAN). The data produced by the tomography modules may be sent to a server executing a service finder application, which may be transferred to an identification database (for example, the identification database 206). Comparison of the characteristics of the print traffic of the printer to print traffic of known printers stored in the identification database 206 may enable the service finder application to identify one or more suspected services of the printer. For example, the suspected services may include the printer being able to receive deliveries from the internet. The specific sizing and timing characteristics may indicate processor capabilities and with enough tomography data 204, a sufficient signature of the printer may be built. The identified suspected services and ability to further process tomography data (for example, operation 208) may allow for data collection specific to the printer. For example, if a particular model of the printer is possibly identified, the system may also tomographically detect firmware update timing and compare against which printers were updated and when. The system may also instruct the tomography modules to use high intensity gathering during specific phases of sessions to obtain detailed header sizes and the like.

Once the printer is detected and services associated with the printer are identified with certainty, the service finder application may suggest an action from the action database 214 (for example, operation 216), such as “There appears to be a model-specific printer device on the network, you may print to the model-specific printer device remotely once you receive the unique email address,” which may result in asking the owner of the model-specific printer device for the unique email address. In some example embodiments, a company may offer a way for the service finder application to provide some identification data (for example, session times, network IP details, geo-location, etc.) and receive the unique email address needed to use the printer, dependent on privacy and user settings. Other scenarios may include identifying a network media device and offering to connect to the media device to enable remote play of songs and movies, or identifying network attached storage and offering to link a device to the storage for backup or transfers.

In other examples, the identification database 206 may be populated by crowd sourcing, where the two or more cooperative devices on the network may characterize other known devices on the network to contribute information to the database. Characterization of the other known devices may enable an automated building of new data profiles for new devices as they become hosted on the network. For example, if a computer desktop system receives installed drivers for a new printer, network tomography may be employed when the computer desktop system interacts with the printer. The tomography data may be used to build a profile of the printer to contribute to the identification database 206 enabling other devices to find the printer. Such a system may allow rapid development of large ubicomp device coverage in the identification database 206 with details including header sizes, buffer-induced pauses, and data rates that vary with processor types and hardware. These details may be used to identify more finely uncooperative devices within a particular class.

The ability to build detailed device profiles automatically without a large testing and profiling effort, and maintain the profiles within the identification database 206, may provide economy of scale to give advantages to larger ecosystem providers. The economy of scale may enable larger ecosystem providers to offer the use of embodiments as a service to other device manufacturers.

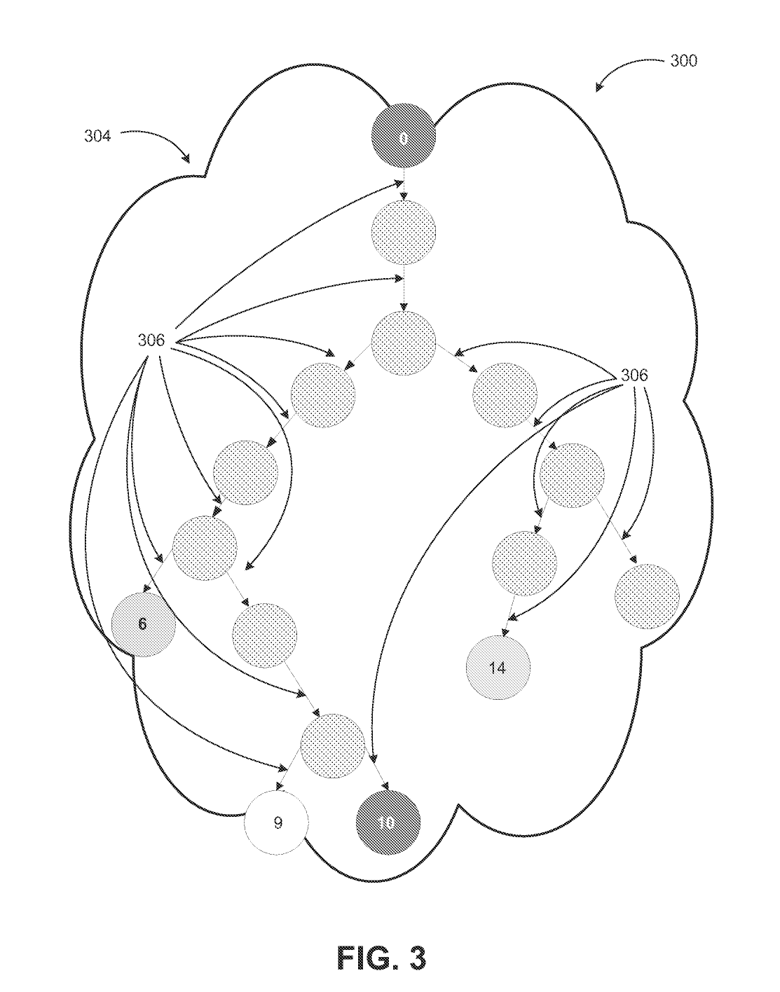

FIG. 3 illustrates a structure of an example network to employ network tomography to detect an uncooperative device and identify services associated with the uncooperative device, arranged in accordance with at least some embodiments described herein.

As shown in a diagram 300, an example network 304 may include cooperative devices 0 and 10 represented by dark nodes and uncooperative devices 6 and 14 represented by grey nodes at different locations in the network 304. An example network access point 9 represented by a white node may link the network to a wide area network (WAN) or the Internet. Additional network devices (irrelevant for the purposes of this illustration) represented as patterned nodes may also be part of the network in various segments. Network links between the cooperative devices, access points, and uncooperative devices are shown as edges 306.

The cooperative devices 0 and 10 may sample the communications of the uncooperative device 6 to any other node including the network access point 9. The cooperative devices 0 and 10 may also sample traffic from the uncooperative device 14 as long as the traffic passes through a path between the cooperative devices 0 and 10, for example, on the way to the uncooperative device 6 or the network access point 9. Upon probing the exchanged data between the cooperative devices 6 or 14 and other devices in the network 304, the cooperative devices 0 and 10 may process the data and discover suspected services for interaction with the uncooperative devices 6 and 14 through an identification database. Alternatively, the cooperative devices 0 and 10 may forward the data to another computing device that may perform the processing and identification of suspected services.

Network tomography is the computational act of measuring small variations in network traffic delivery times at different nodes and performing central computation to extract detailed profiles of traffic over time and target flows. Network tomography may use information derived from point data to derive internal characteristics including traffic information of other known cooperative and uncooperative devices on a network. Some numerical treatments of network tomography generally break a network down into a graph and assemble a matrix of relationships between traffic statistics at known sources and destinations, and the inferred relationships with traffic or delay on various network links. Such systems may infer router link data and network traffic from the uncooperative devices and generally decompose a system into linearly independent components. Decomposing the system may enable subtraction of undesired signals of the known devices from desired signals of the uncooperative devices to detect and characterize the uncooperative devices. Decomposing the system may further enable inference of statistics of target flows to profile a network activity of the uncooperative devices.

To employ network tomography according to some embodiments, two or more cooperative devices that span a network segment used by an uncooperative device may be needed to probe the exchanged data between the cooperative devices. Detection may then be deduced by processing the data exchanged within tomography modules. A functional code may be written for the tomography modules of the cooperative devices, arranged in accordance with at least some embodiments described herein. The functional code may be written using a programming language, a network packet capture library, and executing a network packet-decoding feature without requiring full network stack access. An example functional code is shown below:

from pcapy import findalldevs, 0pen_1ive
from impacket import ImpactDecoder, ImpactPacket
import pcapy
def get_interface( ):

ifs = finda1ldevs( )
if 1en(ifs) == O:

raise RuntimeError, “Error: no available network interfaces, or
you do

if 1en(ifs) == 1:

interface = ifs[O]

else:

print “Available network interfaces:”
for i in xrange(1en(ifs)):

print ‘\t%i −− %s’ % (i + 1, ifs[i])

print
while 1:

choice = raw_input(“Choose an interface [0 to quit]: ”)
try:

i = int(choice)
if i == 0:

interface = None
break

interface = ifs[i−1]
break

except Exception:

pass

return interface

def sniff(interface):

print “Listening on: %s” % interface
reader = open_1ive(interface, 1500, 0, 100)
reader.setfi1ter(‘ip proto \\tcp’)
reader.1oop(O, callback)

def ca11back(hdr, data):
decoder = ImpactDec0der.EthDecoder( )
ether = decoder.decode(data)
iphdr = ether.chi1d( )
tcphdr = iphdr.chi1d( )
src_ip = iphdr.get_ip_src( )
dst_ip = iphdr.get_ip_dst( )

print “Connection %s −> %s” % (src_ip, dst_ip)
print (‘%s: captured %d bytes, truncated to %d bytes’

%(datetime.datetime.now( ), hdr.get1en( ), hdr.getcap1en( )))

print ether

def main( ):

interface = get_interface( )
if interface:

sniff(interface)

if_{——}name_{——} == “_{——}main_{——}”:

main( )

As illustrated in the example functional code above, the traffic from the uncooperative device may be sampled along a path of data, such as the probed network segment, from one cooperative device to at least a second cooperative device. The path of data may be represented in the functional code. While in the current example two points of data per tomographic packet are taken, one for each cooperative device, more tomographic sampling points may be beneficial and any number of ubicomp devices may participate and contribute. A greater number of ubicomp devices may help to eliminate and discriminate traffic from other devices in a network.

In some examples, network packet capture libraries may be under remote control. As a result, one or neither of the cooperative devices may be aware of the service finder application. For example, a first cooperative device may have a tomography module and may install the tomography module on a second cooperative device during a synchronization or a backup, where the second cooperative device may be set to respond to commands from the first cooperative device. In another example, tomography modules of a first cooperative device and a second cooperative device may be controlled remotely by a datacenter. The datacenter may implement the service finder application and suggest one or more actions as a service to the first cooperative device, the second cooperative device, and possibly other devices that were not part of the specific tomographic data capturing. Even if a particular vendor does not manufacture a device, placing an application on the device may be enough to make the device a cooperative device for tomographic data collection. In another example, tomography modules of a first cooperative device and a second cooperative device may be part of an operating system or application with another purpose. In another example, tomography modules of a first cooperative device and a second cooperative device may run from within a browser or as a “packaged application” leveraging browser infrastructure.

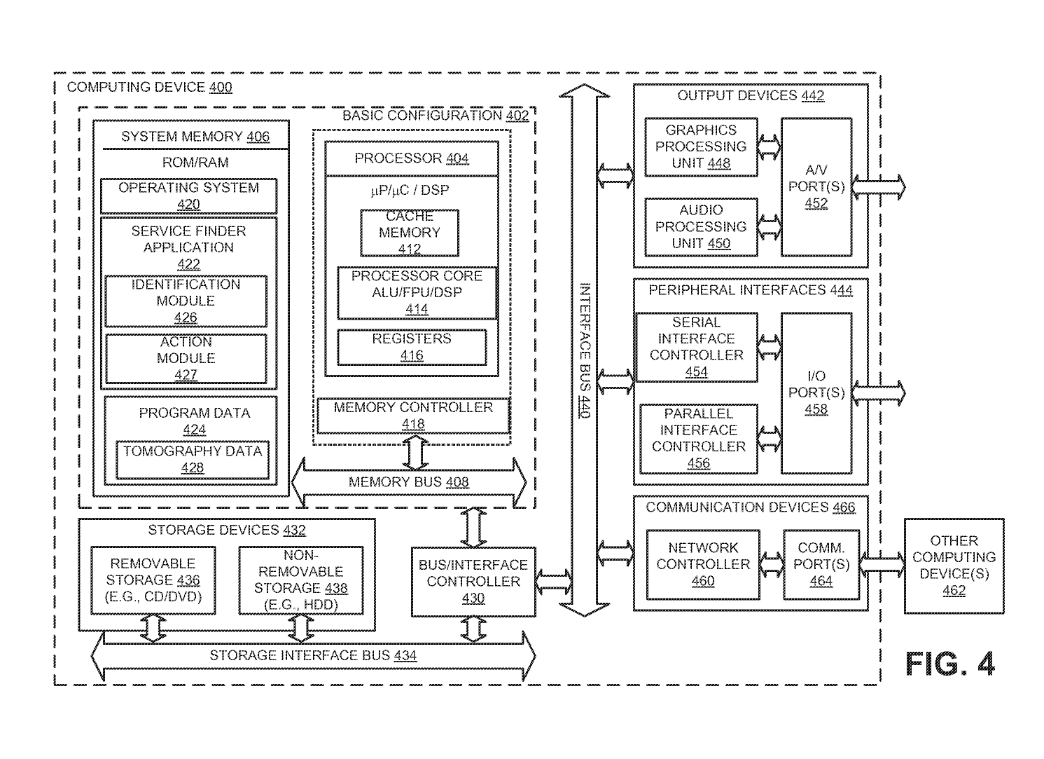

FIG. 4 illustrates a general purpose computing device, which may be used to detect an uncooperative device and identify services associated with the uncooperative device, arranged in accordance with at least some embodiments described herein.

For example, the computing device 400 may be used to detect an uncooperative device and identify services associated with the uncooperative device, as described herein. In an example basic configuration 402, the computing device 400 may include one or more processors 404 and a system memory 406. A memory bus 408 may be used for communicating between the processor 404 and the system memory 406. The basic configuration 402 is illustrated in FIG. 4 by those components within the inner dashed line.

Depending on the desired configuration, the processor 404 may be of any type, including but not limited to a microprocessor (μP), a microcontroller (AC), a digital signal processor (DSP), or any combination thereof. The processor 404 may include one more levels of caching, such as a level cache memory 412, one or more processor cores 414, and registers 416. The example processor cores 414 may (each) include an arithmetic logic unit (ALU), a floating point unit (FPU), a digital signal processing core (DSP Core), or any combination thereof. An example memory controller 418 may also be used with the processor 404, or in some implementations, the memory controller 418 may be an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 may include an operating system 420, a service finder application 422, and program data 424. The service finder application 422 may include an identification module 426 and an action module 427. The identification module 426 may employ an identification database to identify one or more suspected services associated with an uncooperative device by comparing an activity profile of the uncooperative device derived from tomography data to activity profiles of known devices on a network stored in the identification database. The action module 427 may suggest one or more actions from an action database to be performed by a client and/or device in response to the recognized services to enable interaction with the uncooperative device. The program data 424 may include, among other data, tomography data 428 related to network traffic in a probed network segment between two or more cooperative devices, as described herein.

The computing device 400 may have additional features or functionality, and additional interfaces to facilitate communications between the basic configuration 402 and any desired devices and interfaces. For example, a bus/interface controller 430 may be used to facilitate communications between the basic configuration 402 and one or more data storage devices 432 via a storage interface bus 434. The data storage devices 432 may be one or more removable storage devices 436, one or more non-removable storage devices 438, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 406, the removable storage devices 436 and the non-removable storage devices 438 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (for example, one or more output devices 442, one or more peripheral interfaces 444, and one or more communication devices 466) to the basic configuration 402 via the bus/interface controller 430. Some of the example output devices 442 include a graphics processing unit 448 and an audio processing unit 450, which may be configured to communicate to various external devices such as a display or speakers via one or more A/V ports 452. One or more example peripheral interfaces 444 may include a serial interface controller 454 or a parallel interface controller 456, which may be configured to communicate with external devices such as input devices (for example, keyboard, mouse, pen, voice input device, touch input device, etc.) or other peripheral devices (for example, printer, scanner, etc.) via one or more I/O ports 458. An example communication device 466 includes a network controller 460, which may be arranged to facilitate communications with one or more other computing devices 462 over a network communication link via one or more communication ports 464. The one or more other computing devices 462 may include servers, client devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 400 may be implemented as a part of a general purpose or specialized server, mainframe, or similar computer that includes any of the above functions. The computing device 400 may also be implemented as a personal computer including both laptop computer and non-laptop computer configurations.

Example embodiments may also include methods to employ network tomography to detect an uncooperative device and identify services associated with the device. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

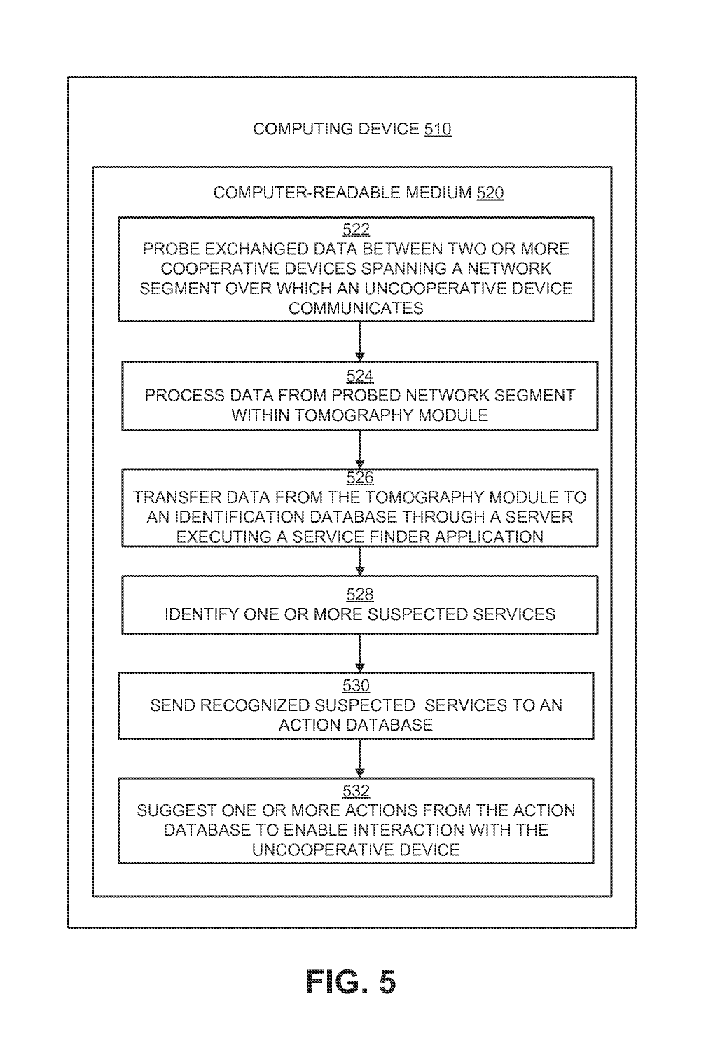

FIG. 5 is a flow diagram illustrating an example method to detect an uncooperative device and identify services associated with the device that may be performed by a computing device such as the computing device in FIG. 4, arranged in accordance with at least some embodiments described herein.

Example methods may include one or more operations, functions or actions as illustrated by one or more of blocks 522, 524, 526, 528, 530, and 532. The operations described in the blocks 522 through 532 may also be stored as computer-executable instructions in a computer-readable medium such as a computer-readable medium 520 of a computing device 510.

An example process to detect an uncooperative device and identify services associated with the uncooperative device may begin with block 522, “PROBE EXCHANGED DATA BETWEEN TWO OR MORE COOPERATIVE DEVICES SPANNING A NETWORK SEGMENT OVER WHICH AN UNCOOPERATIVE DEVICE COMMUNICATES,” where tomography modules (for example, the tomography modules 205) of two or more cooperative devices (for example, the cooperative devices 203) may probe data exchanged between the cooperative devices spanning a network segment that includes traffic from an uncooperative device (for example, the printer 102). The cooperative devices may be on a same network or on two distinct networks.

Block 522 may be followed by block 524, “PROCESS DATA FROM PROBED NETWORK SEGMENT WITHIN TOMOGRAPHY MODULE,” where the tomography modules of the cooperative devices process the data from the probed network segment. The tomography modules may employ network tomography to detect and profile an activity of known devices and/or any uncooperative device(s) on the network. The processed data may include or indicate statistics and patterns of network traffic of the cooperative devices and/or any uncooperative device(s).

Block 524 may be followed by block 526, “TRANSFER DATA FROM THE TOMOGRAPHY MODULE TO AN IDENTIFICATION DATABASE THROUGH A SERVER EXECUTING A SERVICE FINDER APPLICATION,” where the processed tomography data (for example, the tomography data 204) may be initially transferred from the tomography modules of the cooperative devices to a server (for example, the server 202) associated with the devices. The server may execute a service finder application, which may be a local application or a cloud application. The server may then transfer the processed tomography data to an identification database (for example, the identification database 206). In other examples, the operations including, but not limited to, transfer of data and service identification may be performed on the same device, for example, a known device on the network.

Block 526 may be followed by block 528, “IDENTIFY ONE OR MORE SUSPECTED SERVICES,” where the executed service finder application may use the tomography data to compare an activity profile of the uncooperative device(s) to activity profiles of known devices stored in the identification database to identify the suspected services. The service finder application may further determine certainty levels of the suspected services. If no suspected services are found and/or the certainty levels of the suspected services are low (for example, the operation 208), the service finder application may request more tomography be processed within the tomography modules of the cooperative devices. The identification database may be populated by crowd sourcing.

Block 528 may be followed by block 530, “SEND RECOGNIZED SUSPECTED SERVICES TO ACTION DATABASE,” where the service finder application may be configured to send recognized suspected services (for example, the operation 212) to an action database (for example, the action database 214) in response to determination that the suspected services have high certainty levels of recognition.

Block 530 may be followed by block 532, “SUGGEST ONE OR MORE ACTIONS TO ENABLE INTERACTION WITH THE UNCOOPERATIVE DEVICE,” where the service finder application may suggest actions (for example, the operation 216) from the action database to enable interaction with the uncooperative device(s). The actions may include providing instructions to prompt a user to perform an action, delivering and installing software to one or more detected uncooperative devices, delivering and installing software to one or more cooperative devices, and arranging for co-operation between the uncooperative device and one or more cooperative devices.

The blocks included in the above described process are for illustration purposes. Detection of an uncooperative device and identification of services associated with the uncooperative device may be implemented by similar processes with fewer or additional blocks. In some embodiments, the blocks may be performed in a different order. In some other embodiments, various blocks may be eliminated. In still other embodiments, various blocks may be divided into additional blocks, or combined together into fewer blocks.

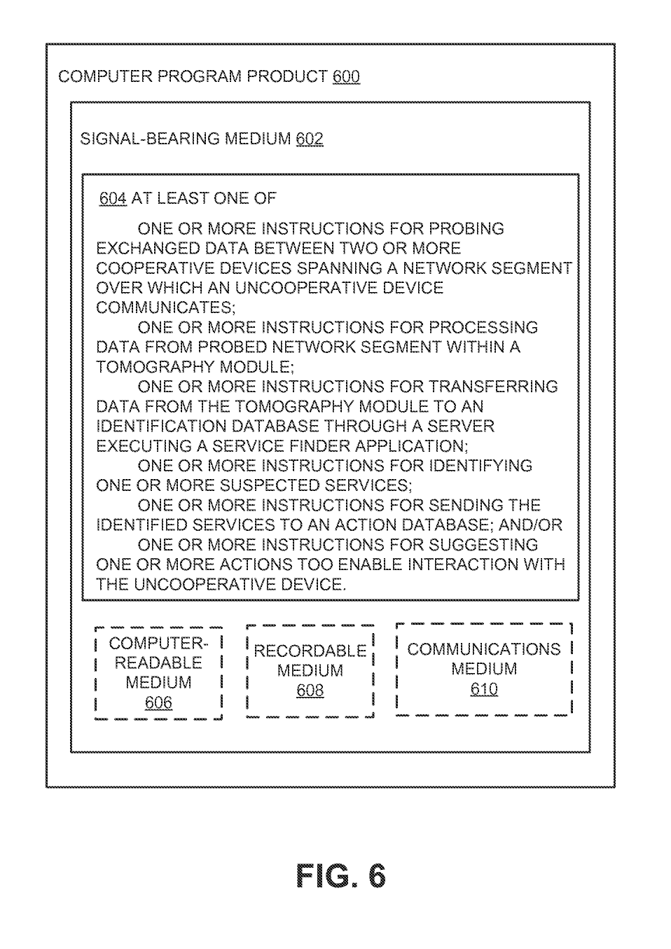

FIG. 6 illustrates a block diagram of an example computer program product, arranged in accordance with at least some embodiments described herein.

In some embodiments, as shown in FIG. 6, the computer program product 600 may include a signal bearing medium 602 that may also include one or more machine readable instructions 604 that, when executed by, for example, a processor, may provide the functionality described herein. Thus, for example, referring to the processor 404 in FIG. 4, an identification module 426 and an action module 427 executed on the processor 404 may undertake one or more of the tasks shown in FIG. 6 in response to the instructions 604 conveyed to the processor 404 by the medium 602 to perform actions associated with establishing secure communications to manage components of a control system as described herein. Some of those instructions may include, for example, instructions for probing exchanged data between two or more cooperative devices spanning a network segment used by an uncooperative device, processing data from the probed network segment within a tomography module, transferring data from the tomography module to an identification database through a server executing a service finder application, identifying one or more suspected services, sending the identified services to an action database, and suggesting one or more actions to enable interaction with the uncooperative device, according to some embodiments described herein. As discussed above, some or all of the operations may be performed on the same device. For example, a computing device on the same network segment or another segment may probe and process the exchanged data, query the identification database, and identify the suspected services. Thus, data may not need to be moved elsewhere through a server to use the service finder application.

In some implementations, the signal bearing medium 602 depicted in FIG. 6 may encompass a computer-readable medium 606, such as, but not limited to, a hard disk drive, a solid state drive, a Compact Disc (CD), a Digital Versatile Disk (DVD), a digital tape, memory, etc. In some implementations, the signal bearing medium 602 may encompass a recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (for example, a fiber optic cable, a waveguide, a wired communications link, a wireless communication link, etc.). Thus, for example, the program product 600 may be conveyed to one or more modules of the processor 404 of FIG. 4 by an RF signal bearing medium, where the signal bearing medium 602 is conveyed by the wireless communications medium 610 (for example, a wireless communications medium conforming with the IEEE 802.11 standard).

According to some examples, a method to detect an uncooperative device and identify services associated with the uncooperative device is provided. An example method may include probing exchanged data between two or more cooperative devices spanning a network segment over which the uncooperative device communicates and processing data from the probed network segment within a tomography module of each of the two or more cooperative devices. The method may also include using the processed data from each tomography module to identify one or more suspected services through an identification database. The method may further include sending the identified services to an action database and suggesting one or more actions to enable interaction with the uncooperative device.

In other examples, network tomography may be employed in the tomography module of each of the two or more cooperating devices to detect the uncooperative device and profile an activity of the uncooperative device. Employing network tomography may include decomposing the probed network segment into linearly independent components to detect the uncooperative device and to profile the activity of the uncooperative device upon detection. The decomposed probed network segment may enable subtraction of known signals of cooperative devices from suspected signals of the uncooperative device to detect the uncooperative device.

In further examples, identification of the one or more suspected services may include comparing an activity profile of the uncooperative device against activity profiles of known devices within the identification database, where certainty levels associated with the one or more suspected services are also determined. Further data from the tomography module may be processed if certainty levels are low or no suspected services are found. The identification database may be populated by crowd-sourcing. The one or more actions suggested may include providing instructions to prompt a user to perform an action, delivering and installing software to one or more detected uncooperative devices, and arranging for co-operation between the uncooperative device and one or more cooperative devices.

According to some embodiments, a service to detect an uncooperative device and identify services associated with the uncooperative device is described. An example service may include an identification database, an action database, and one or more servers configured to execute a service finder application. The service finder application may be configured to receive data from tomography modules of two or more cooperative devices, where the two or more cooperative devices share a network segment over which the uncooperative device communicates. The service finder application may also be configured to use the processed data from each tomography module to identify one or more suspected services associated with the uncooperative device through an identification database. The service finder application may further be configured to send the identified services to the action database, and suggest one or more actions from the action database to enable interaction with the uncooperative device.

In other embodiments, the data received from the tomography modules of two or more cooperative devices may include data exchanged between the two or more cooperative devices. Network tomography may be employed in the tomography modules of each of the two or more cooperating devices to detect the uncooperative device and profile an activity of the comparison of the activity profile of the uncooperative device against activity profiles of known network devices within the identification database, where the identification database may be populated by crowd-sourcing. The identification database may further determine a certainty level of the one or more suspected detections of service.

In further embodiments, further data from the tomography modules may be processed in response to a determination that one of: the certainty levels associated with the one or more suspected services are low and no suspected services are found. The suggested actions may include instructions to prompt a user to perform an action, delivery and installation of software to one or more detected uncooperative devices, and arrangement of co-operation between the uncooperative device and one or more cooperative devices.

According to some examples, a server to detect an uncooperative device and identify services associated with the uncooperative device is described. An example server may include a memory configured to store instructions, a communication module; and a processor coupled to the memory and the communication module, the processor operable to execute a control manager. The control manager may be configured to probe exchanged data between two or more cooperative devices spanning a network segment over which the uncooperative device communicates. The control manager may also be configured to use the probed data to identify one or more suspected services associated with the uncooperative device through an identification database. The control manager may further be configured to send the identified services to an action database and suggest one or more actions to enable interaction with the uncooperative device.

In other examples, network tomography between the two or more cooperative devices may be employed to process the exchanged data in the tomography modules. The network segment may be decomposed into linearly independent components to detect the uncooperative device and an activity of the uncooperative device may be profiled upon detection, where the data allows detection and activity profiling of the uncooperative device. The one or more suspected services may be identified by comparing an activity profile of the uncooperative device against activity profiles of known network devices within the identification database. The control manager may be further configured to determine certainty levels for the one or more suspected services.

In further examples, further data may be processed from the tomography modules in response to a determination that the certainty levels associated with the one or more suspected services are low and no suspected services are found. The identification database may be populated by crowd-sourcing. The suggested actions may include instructions to prompt a user to perform an action, delivery and installation of software to one or more detected uncooperative devices, and arrangement of co-operation between the uncooperative device and one or more cooperative devices.

According to some embodiments, a cooperative networked computing device to detect an uncooperative device and identify services associated with the uncooperative device is described. The computing device may include a memory configured to store instructions, a communication module, and a processor coupled to the memory and the communication module, the processor operable to execute a tomography module. The tomography module may be configured to probe data exchanged with another cooperative device over a network segment over which the uncooperative device communicates and capture and process the data from the probed network segment. The tomography module may also be configured to send the processed data to an identification database through the communication module and perform one or more actions provided by an action database based on an identification of the uncooperative device using the processed data to enable interaction of the uncooperative device.

In other embodiments, the uncooperative device and the cooperative computing device may be on a same network or two distinct networks. A cooperative computing device may be a client device and the uncooperative device may be a ubicomp device. The processor may be configured to install the tomography module on a second cooperative computing device during a synchronization operation, where the tomography module may be controlled remotely by a datacenter.

In further embodiments, the network segment may be decomposed into linearly independent components to detect and profile network activity of the uncooperative device. The data sent to the identification database may be used to identify one or more suspected services, where the one or more suspected services are identified based on a comparison of an activity profile of the uncooperative device against activity profiles of known network devices within the identification database.

According to some examples, a computer readable memory device with instructions stored thereon is described, which when executed on one or more computing devices may execute a method for detecting an uncooperative network device and identifying associated services. The method may be similar to the example method discussed above.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various examples of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example, as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular examples described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A typical data processing system may be implemented utilizing any suitable commercially available components, such as those typically found in systems employing network tomography to detect and identify unknown devices and/or services associated with those devices. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected,” or “operably coupled,” to each other to achieve the desired functionality, and any two components capable of being so associated may also be viewed as being “operably couplable.” to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to detect an uncooperative device and identify services associated with the uncooperative device, the method comprising:
probing exchanged data between two or more cooperative devices spanning a network segment over which the uncooperative device communicates;
processing data from the probed network segment within a tomography module of each of the two or more cooperative devices that employs network tomography to process the data from the probed network segment, wherein the probed network segment is decomposed into linearly independent components to detect and profile an activity of the uncooperative device;
using the processed data from each tomography module to identify one or more suspected services through an identification database;
sending the identified services to an action database; and
suggesting one or more actions to enable interaction with the uncooperative device.

2-3. (canceled)

4. The method of claim 1, wherein the decomposed probed network segment enables subtraction of known signals of cooperative devices from suspected signals of the uncooperative device to detect the uncooperative device.

5. The method of claim 1, wherein identifying the one or more suspected services comprises comparing the activity profile of the uncooperative device against activity profiles of known network devices within the identification database.

6. The method of claim 5, further comprising:
determining certainty levels associated with the one or more suspected services.

7. The method of claim 1, further comprising:
processing further data from the tomography module if one of: certainty levels are low or no suspected services are found.

8. The method of claim 1, further comprising:
populating the identification database by crowd-sourcing.

9. The method of claim 1, wherein suggesting one or more actions comprises:
providing instructions to prompt a user to perform an action;
delivering and installing software to one or more detected uncooperative devices; and
arranging for co-operation between the uncooperative device and one or more cooperative devices.

10. A service to detect an uncooperative device and identify services associated with the uncooperative device, the service comprising:
an identification database;
an action database; and
one or more servers configured to execute a service finder application, wherein the service finder application is configured to:
receive processed data comprising an activity profile of a detected uncooperative device from tomography modules of two or more cooperative devices, wherein the two or more cooperative devices share a network segment over which the uncooperative device communicates;
use the processed data from each tomography module to identify one or more suspected services associated with the uncooperative device through an identification database;
send the identified services to the action database; and
suggest one or more actions from the action database to enable interaction with the uncooperative device.

11. The service of claim 10, wherein the data received from the tomography modules of two or more cooperative devices comprises data exchanged between the two or more cooperative devices.

12. The service of claim 1, wherein network tomography is employed in the tomography modules of each of the two or more cooperating devices to detect the uncooperative device and profile the activity of the uncooperative device.

13. The service of claim 12, wherein the one or more suspected services are identified based on a comparison of the activity profile of the uncooperative device against activity profiles of known network devices within the identification database.

14. The service of claim 10, wherein the identification database is populated by crowd-sourcing.

15. The service of claim 10, wherein the identification database further determines a certainty level of the one or more suspected detections of service.

16. The service of claim 15, wherein further data from the tomography modules is processed in response to a determination that one of: the certainty levels associated with the one or more suspected services are low and no suspected services are found.

17. The service of claim 10, wherein the suggested actions include one or more of: instructions to prompt a user to perform an action, delivery and installation of software to one or more detected uncooperative devices, and arrangement of co-operation between the uncooperative device and one or more cooperative devices.

18-26. (canceled)

27. A cooperative networked computing device to detect an uncooperative device and identify services associated with the uncooperative device, the computing device comprising:
a memory configured to store instructions;
a communication module; and
a processor coupled to the memory and the communication module, the processor operable to execute a tomography module, wherein the tomography module is configured to:
probe data exchanged with another cooperative device over a network segment over which the uncooperative device communicates;
capture and process the data from the probed network segment employing network tomography to process the data from the probed network segment, wherein the probed network segment is decomposed into linearly independent components to detect and profile an activity of the uncooperative device;
send the processed data to an identification database through the communication module; and
perform one or more actions provided by an action database based on an identification of the uncooperative device using the processed data to enable interaction of the uncooperative device.

28. The computing device of claim 27, wherein the uncooperative device and the cooperative computing device are on one of: a same network and two distinct networks.

29. The computing device of claim 27, wherein a cooperative computing device is a client device.

30. The computing device of claim 27, wherein the uncooperative device a ubicomp device.

31. The computing device of claim 27, wherein the processor is configured to install the tomography module on a second cooperative computing device during a synchronization operation.

32. The computing device of claim 31, wherein the tomography module is controlled remotely by a datacenter.

33. (canceled)

34. The computing device of claim 27, wherein the data sent to the identification database is used to identify one or more suspected services.

35. The computing device of claim 34, wherein the one or more suspected services are identified based on a comparison of the activity profile of the uncooperative device against activity profiles of known network devices within the identification database.

36. (canceled)
